(19) United States
(12) Patent Application Publication
(10) Pub. No.: US 2018/0212507 A1
(43) Pub. Date: Jul. 26, 2018

(54) MULTI-FUNCTION POWER CONVERTING APPARATUS

(71) Applicant: National Tsing Hua University, Hsinchu City (TW)

(72) Inventors: Tsai-Fu Wu, Hsinchu City (TW); Po-Hung Lee, Hsinchu City (TW); Cheng-Kuang Hsieh, Hsinchu City (TW); Jeng-Jang Hsu, Hsinchu City (TW)

(73) Assignee: National Tsing Hua University, Hsinchu City (TW)

(21) Appl. No.: 15/823,594

(22) Filed: Nov. 28, 2017

(30) Foreign Application Priority Data
Jan. 20, 2017 (TW) 106102021

(51) Int. Cl. H02M 1/08; H02M 7/42

(52) U.S. Cl. CPC H02M 1/08; H02M 2001/0003; H02M 7/42

(57) ABSTRACT

A multi-function power converting apparatus including an inverter circuit and a controller is provided. The inverter circuit drives a load. The controller generates a control signal according to a sampled DC voltage, a sampled AC voltage, a load current, and an output current. The controller causes the inverter circuit to enter an uninterruptible power supply mode or a grid-connected power supply mode through the control signal. Specifically, when the inverter circuit enters the grid-connected power supply mode, the multi-function power converting apparatus operates in one of a mixed real-virtual power output mode, a rectification charging mode, an active filtering mode, and an active power balancing mode.

### CROSS-REFERENCE TO RELATED APPLICATION

This application claims the priority benefit of Taiwan application serial no. 106102021, filed on Jan. 20, 2017. The entirety of the above-mentioned patent application is hereby incorporated by reference herein and made a part of this specification.

### BACKGROUND OF THE INVENTION

### Field of the Invention

The invention relates to a multi-function power converting apparatus, and in particular, a multi-function power converting apparatus simultaneously having a plurality of functions.

### Description of Related Art

With the rise in environmental awareness, renewable energies have become indispensable alternative energies. One of the renewable energies mainly directly or indirectly comes from the sun. As sunlight enters the atmosphere and reaches the earth surface, it exhibits characteristics of discontinuity and instability due to the effect of weather and cloud layer. Therefore, this renewable energy requires special processing when in use. In particular, in the application to microgrid power supply, more comprehensive power dispatch, management, control, and reservation/storage are required in order to stably supply high-quality power. As the percentage of the power supplied by renewable energies rises each year, the installment of microgrids also becomes more and more prevalent. The connection and split therebetween will be an important issue for research in power dispatch of microgrids.

Mainly serving to supply regional load power, microgrids are intended for power consumption upon generation and power supply to close proximity and function to reduce the impact on the original grids. Currently, the overall system framework of microgrids generally includes distributed power sources along with renewable energies and energy storage devices that function with high-power converters, and the system may finally connect to microgrids.

When grid power supply is normal, microgrids play an auxiliary role by modifying the quality of grid power supply, improving power demand at the users' end, and easing the burden on power generators. However, when grid power supply is abnormal, microgrids use renewable energies as the source of power supply and support power demand at the regional users' end. Accordingly, it is indispensable to introduce a multi-function three-phase power converting apparatus as the modulation hub in the trend of microgrid power.

### SUMMARY OF THE INVENTION

The invention provides a multi-function power converting apparatus that operates in a plurality of different modes and has a plurality of functions.

The multi-function power converting apparatus of the invention includes an inverter circuit and a controller. The inverter circuit drives a load and is coupled to a DC power source and an AC power grid. The inverter circuit includes a plurality of switches, wherein the switches perform switch operations according to a control signal to execute a power converting operation. The controller is coupled to the inverter circuit, the DC power source, and the AC power grid. The controller samples voltages of the DC power source and the AC power grid to respectively obtain a sampled DC voltage and a sampled AC voltage, samples a load current of the load and an output current of the inverter circuit, and generates the control signal according to the sampled DC voltage, the sampled AC voltage, the load current, and the output current. The controller causes the inverter circuit to enter an uninterruptible power supply mode or a grid-connected power supply mode through the control signal. The multi-function power converting apparatus operates in one of a mixed real-virtual power output mode, a rectification charging mode, an active filtering mode, and an active power balancing mode, when the inverter circuit enters the grid-connected power supply mode.

In light of the above, through detecting a state of the AC power grid and a demand state at the load end, the multi-function power converting apparatus of the invention may operate in a plurality of different modes, such that the multi-function power converting apparatus is provided with five main functions to thereby enhance efficiency of the power system in power transmission, application, and storage.

To provide a further understanding of the aforementioned and other features and advantages of the invention, exemplary embodiments, together with the reference drawings, are described in detail below.

### BRIEF DESCRIPTION OF THE DRAWINGS

FIG. 1 is a schematic diagram illustrating a multi-function power converting apparatus of an embodiment of the invention.

FIG. 2 illustrates an operation procedure of a multi-function power converting apparatus of an embodiment of the invention.

FIG. 3A to FIG. 3C illustrate current waveform diagrams of an active power filtering mode of an embodiment of the invention.

FIG. 4A to FIG. 4C illustrate current waveform diagrams of an active power balancing mode of an embodiment of the invention.

FIG. 5 illustrates an output current waveform diagram of a rectification charging mode of an embodiment of the invention.

FIG. 6A to FIG. 6C illustrate output current waveform diagrams of a mixed real-virtual power output mode of an embodiment of the invention.

FIG. 7A and FIG. 7B are current waveform diagrams respectively illustrating virtual power compensation of an embodiment of the invention.

FIG. 8 is a schematic diagram illustrating a multi-function power converting apparatus of another embodiment of the invention.

FIG. 9A is a flowchart illustrating a working procedure of a multi-function power converting apparatus of an embodiment of the invention.

FIG. 9B a flowchart illustrating another working procedure of a multi-function power converting apparatus of an embodiment of the invention.

### DESCRIPTION OF THE EMBODIMENTS

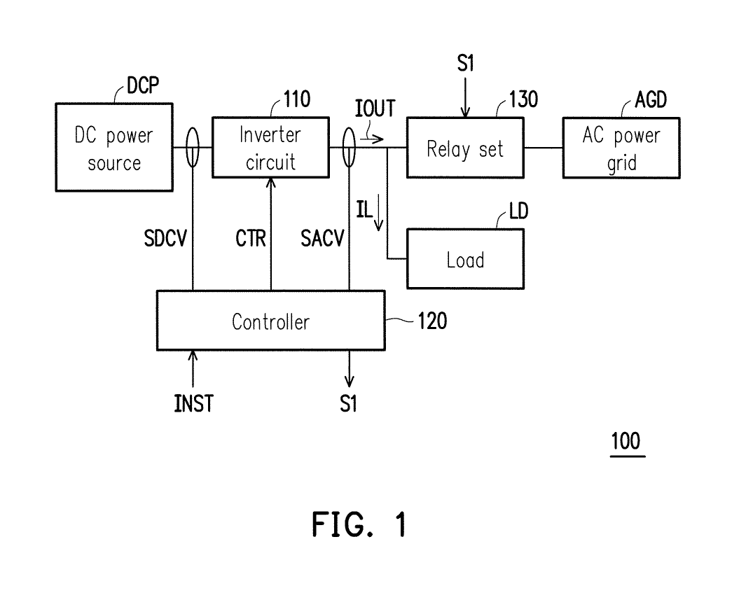

Referring to FIG. 1, FIG. 1 is a schematic diagram illustrating a multi-function power converting apparatus of an embodiment of the invention. A multi-function power converting apparatus 100 includes an inverter circuit 110, a controller 120, and a relay set 130. The inverter circuit 110 is coupled to a DC power source DCP and an AC power grid AGD and drives a load LD. The inverter circuit 110 includes a plurality of switches. The switches perform switch operations according to a control signal CTR and thereby execute power converting operations. The controller 120 is coupled to the inverter circuit 110 and the DC power source DCP, and is coupled to the AC power grid AGD via the relay set 130. The controller 120 samples voltages on the DC power source DCP and the AC power grid AGD and respectively obtains a sampled DC voltage SDCV and a sampled AC voltage SACV. The controller 120 further samples a load current IL of the load LD and an output current IOUT of the inverter circuit 110. Next, the controller 120 generates the control signal CTR according to the sampled DC voltage SDCV, the sampled AC voltage SACV, the load current IL, and the output current IOUT. Specifically, the controller 120 causes the inverter circuit 110 to enter an uninterruptible power supply mode or a grid-connected power supply mode through the control signal CTR.

Moreover, when the inverter circuit 110 enters the grid-connected power supply mode, the multi-function power converting apparatus 100 operates in one of a mixed real-virtual power output mode, a rectification charging mode, an active filtering mode, and an active power balancing mode. Specifically, the controller 120 receives an instruction INST and generates the control signal CTR according to the instruction INST. The inverter circuit 110 receives the control signal CTR and controls the switch operations of the switches therein through the control signal CTR, such that the multi-function power converting apparatus 100 can operate in one of the mixed real-virtual power output mode, the rectification charging mode, the active filtering mode, and the active power balancing mode.

Regarding the working details of the multi-function power converting apparatus 100, the controller 120 determines whether functioning of the AC power grid AGD is normal according to the sampled AC voltage SACV. According to the determination on whether functioning of the AC power grid AGD is normal, the controller 120 generates a signal S1 and transmits the signal S1 to the relay set 130 to control an on or off state of the relay set 130. Moreover specifically, the inverter circuit 110 is coupled to the AC power grid AGD via the relay set 130, and the on or off state of the relay set 130 is controlled according to the signal S1. When the controller 120 determines that functioning of the AC power grid AGD is normal, the relay set 130 is turned on through the generated signal S1, and the inverter circuit 110 and the AC power grid AGD are connected to each other. Conversely, when the controller 120 determines that functioning of the AC power grid AGD is abnormal, the relay set 130 is turned off through the generated signal S1, and the inverter circuit 110 and the AC power grid AGD are isolated from each other.

When the inverter circuit 110 and the AC power grid AGD are connected to each other, the inverter circuit 110 operates in the grid-connected mode. When the inverter circuit 110 and the AC power grid AGD are isolated from each other, the inverter circuit 110 operates in the uninterruptible power supply mode.

In the present embodiment, the controller 120 learns whether the AC power grid AGD functions normally through a voltage state of the sampled AC voltage SACV. The operations for detecting whether the AC power grid functions normally that are familiar to people of ordinary skill in the art can all be applied to the invention without specific restrictions.

When the inverter circuit 110 operates in the uninterruptible power supply mode, the inverter circuit 110 stops receiving an output voltage supplied by the AC power grid AGD. Meanwhile, the inverter circuit 110 converts the voltage of the DC power source DCP according to the control signal CTR to generate an output voltage and supplies power to the load LD by using the output voltage. Here, the DC power source DCP may be an energy storage device (e.g., a battery) for supplying the DC power source.

On the other hand, when the inverter circuit 110 operates in the grid-connected mode, the multi-function power converting apparatus further operates in one of the mixed real-virtual power output mode, the rectification charging mode, the active filtering mode, and the active power balancing mode.

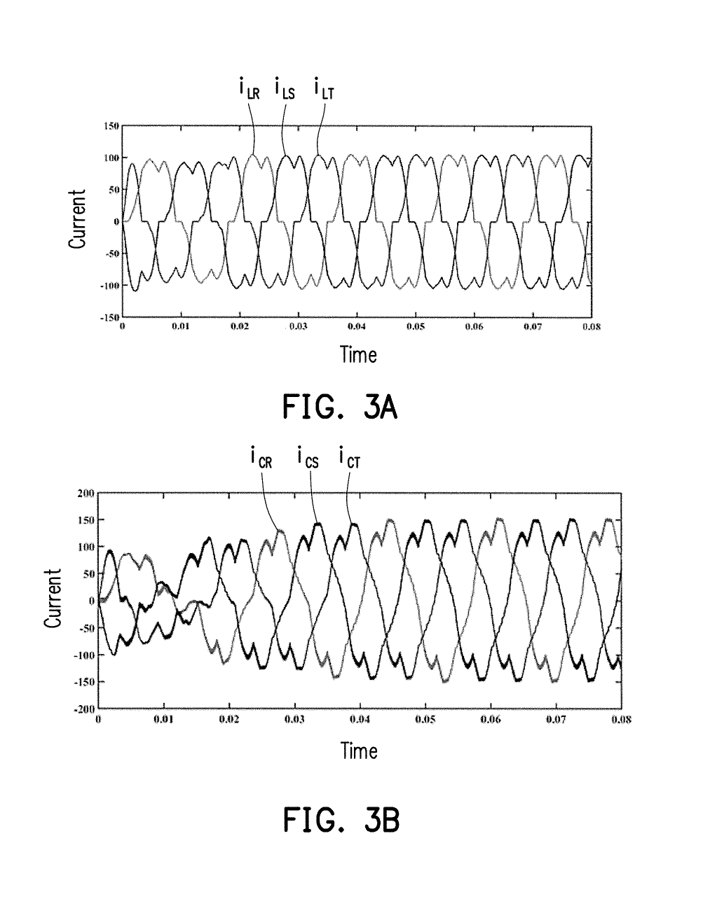

First, regarding the active power filtering mode, the controller 120 is activated when a power demand of a pulse-type current surge arises in the load LD. Referring to FIG. 3A to FIG. 3C illustrating current waveform diagrams of the active power filtering mode of an embodiment of the invention. Specifically, in FIG. 3A, when the power demand of the pulse-type current surge arises in the load LD, load currents i_{LR}, i_{LS}, and i_{LT} at an end of the load LD cannot present complete sinusoidal signals but include defects in some segments.

When the controller 120 detects the defects of the load currents i_{LR}, i_{LS}, and i_{LT} at the end of the load LD as shown in FIG. 3A, the controller 120 correspondingly generates the control signal CTR to control the inverter circuit 110 to generate compensating currents i_{CR}, i_{CS}, and i_{CT} as shown in FIG. 3B. Moreover, in the grid-connected mode, the compensating currents i_{CR}, i_{CS}, and i_{CT} compensate the load currents i_{LR}, i_{LS} and i_{LT}, generate output currents i_{GS}, i_{GT}, and i_{GR} after compensation as shown in FIG. 3C, and correspondingly generate output voltages V_{GS}, V_{GT}, and V_{GR} after compensation.

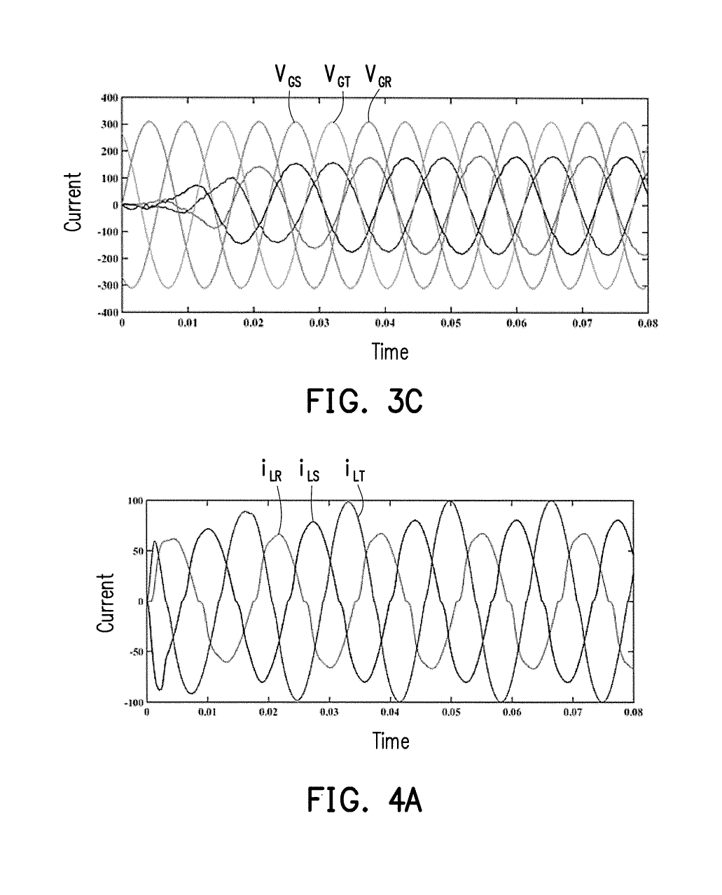

Regarding the active power balancing mode, referring to FIG. 4A to FIG. 4C illustrating current waveform diagrams of the active power balancing mode of an embodiment of the invention. In FIG. 4A, since a current demand of the load LD (at a user's end) is unbalanced on each phase, load currents i_{LR}, i_{LS}, and i_{LT} at the end of the load LD may exhibit inconsistent amplitudes. In this condition, the active power balancing mode is activated. Moreover, the controller 110 correspondingly generates the control signal CTR to control the inverter circuit 110 to generate compensating currents i_{CR}, i_{CS} and i_{CT} as shown in FIG. 4B. In addition, in the grid connected mode, the compensating currents i_{CR}, i_{CS}, and i_{CT} compensate the load currents i_{LR}, i_{LS}, and i_{LT}, generate output currents i_{GS}, i_{GT}, and i_{GR} after compensation as shown in FIG. 4C, and correspondingly generate output voltages V_{GS}, V_{GT}, and V_{GR} after compensation.

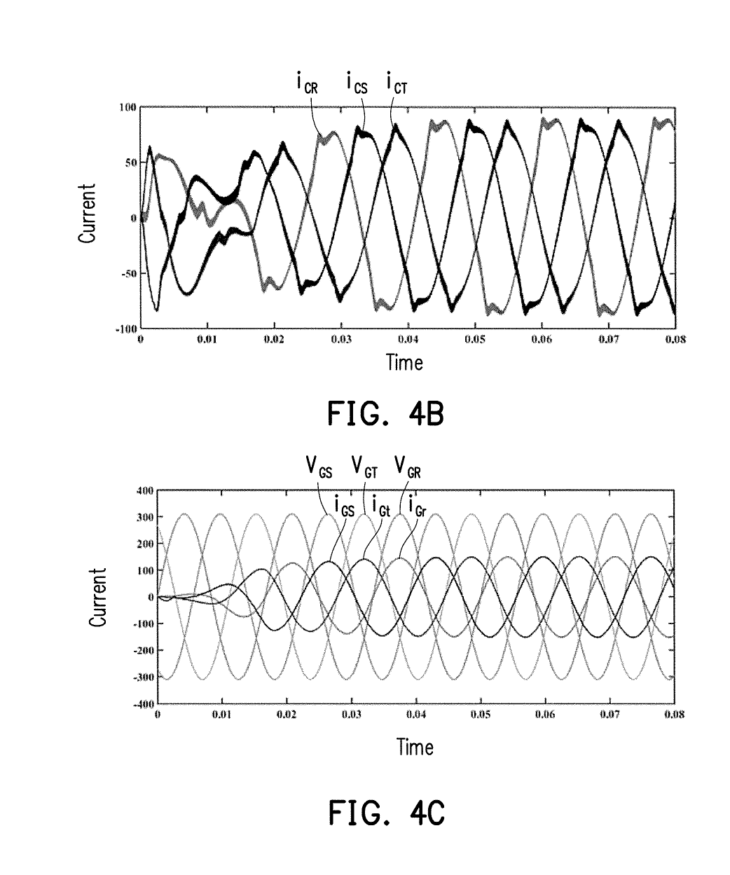

Regarding the rectification charging mode, referring to FIG. 5 illustrating an output current waveform diagram of the rectification charging mode of an embodiment of the invention. When the multi-function power converting apparatus 100 operates in the rectification charging mode, the controller 120 generates the control signal CTR to cause the inverter circuit 110 to feed in a real power supplied by output voltages V_{RN}, V_{SN}, and V_{TN} and output currents i_{RN}, i_{SN}, and i_{TN} on the AC power grid AGD and thereby generate a charging voltage. The inverter circuit 110 further supplies the charging voltage to charge the DC power source DCP. In the present embodiment, the rectification charging mode may be activated when a power stored in the DC power source DCP is less than a threshold value.

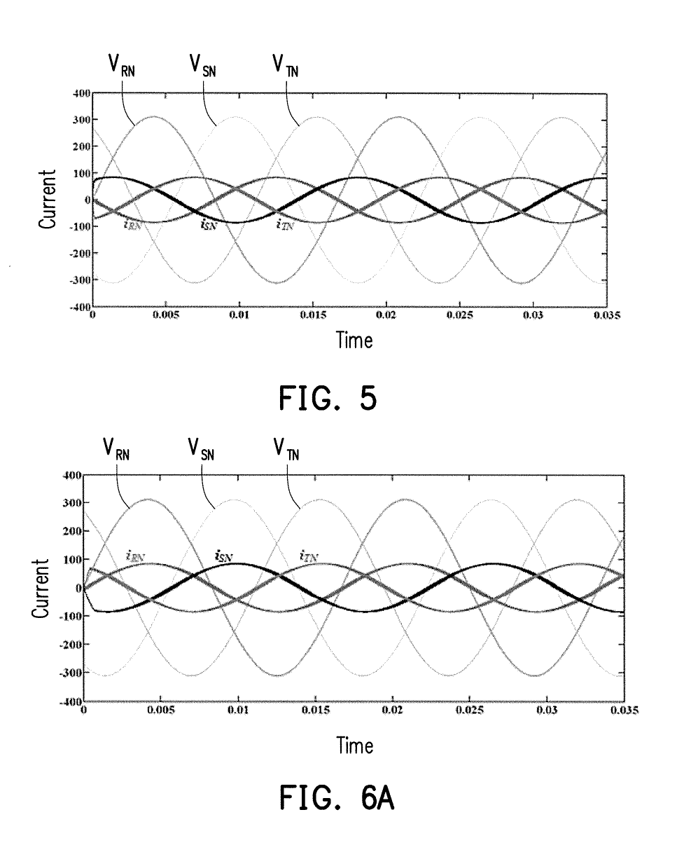

Regarding the mixed real-virtual power output mode, referring to FIG. 6A to FIG. 6C illustrating output current waveform diagrams of the mixed real-virtual power output mode of an embodiment of the invention. The controller 120 generates the control signal CTR according to a power factor (PF) of the sampled AC voltage SACV and causes the inverter circuit 110 to supply at least one of a real power and a virtual power to the AC power grid AGD through the control signal CTR.

Specifically, in FIG. 6A, output voltages V_{RN}, V_{SN}, and V_{TN} supplied by the AC power grid AGD do not substantially exhibit a phase difference respectively from AC currents i_{RN}, i_{SN}, and i_{TN} supplied. In other words, the power factor is equal to 1. When the power factor is equal to 1, the inverter circuit 110 only supplies a purely real power of a positive value to the AC power grid AGD.

Moreover, in FIG. 6B, phases of the output voltages V_{RN}, V_{SN}, and V_{TN} supplied by the AC power grid AGD respectively lead phases of the AC currents i_{RN}, i_{SN}, and i_{TN} supplied. In other words, the phase of the power factor is leading. In addition, when the phase of the power factor is leading, the inverter circuit 110 supplies a purely real power of a positive value to the AC power grid AGD and the AC power grid AGD absorbs a purely virtual power of a positive value. Furthermore, in FIG. 6C, the phases of the output voltages V_{RN}, V_{SN}, and V_{TN} supplied by the AC power grid AGD respectively lag behind the phases of the AC currents i_{RN}, i_{SN}, and i_{TN} supplied. In other words, the phase of the power factor is lagging. When the phase of the power factor is lagging, the inverter circuit 110 supplies a purely real power of a positive value and a purely virtual power of a positive value to the AC power grid AGD.

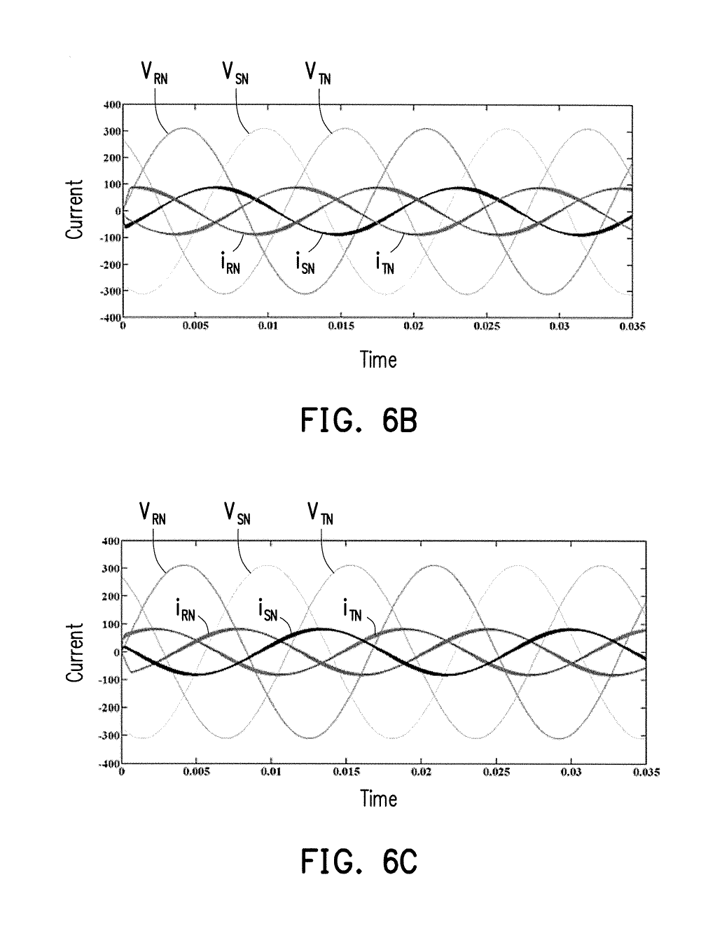

It shall also be mentioned that referring to FIG. 7A and FIG. 7B, FIG. 7A and FIG. 7B are current waveform diagrams respectively illustrating virtual power compensation of an embodiment of the invention. Specifically, in the rectification charging mode, a total capacity of the charging voltage is not necessarily all used to charge the DC power source DCP, but can accomplish virtual power compensation by using control techniques of “a real-virtual power left half plane”. FIG. 7A represents waveforms of the output voltages V_{RN}, V_{SN}, and V_{TN} and the output currents i_{RN}, i_{5N}, and i_{TN} of the AC power grid performing positive virtual power compensation. FIG. 7B represents waveforms of the output voltages V_{RN}, V_{SN}, and V_{TN} and the output currents i_{RN}, i_{SN}, and i_{TN} of the AC power grid performing negative virtual power compensation.

It shall also be mentioned that regarding the foregoing embodiments, the controller 120 may generate the control signal CTR through a D-sigma digital control algorithm.

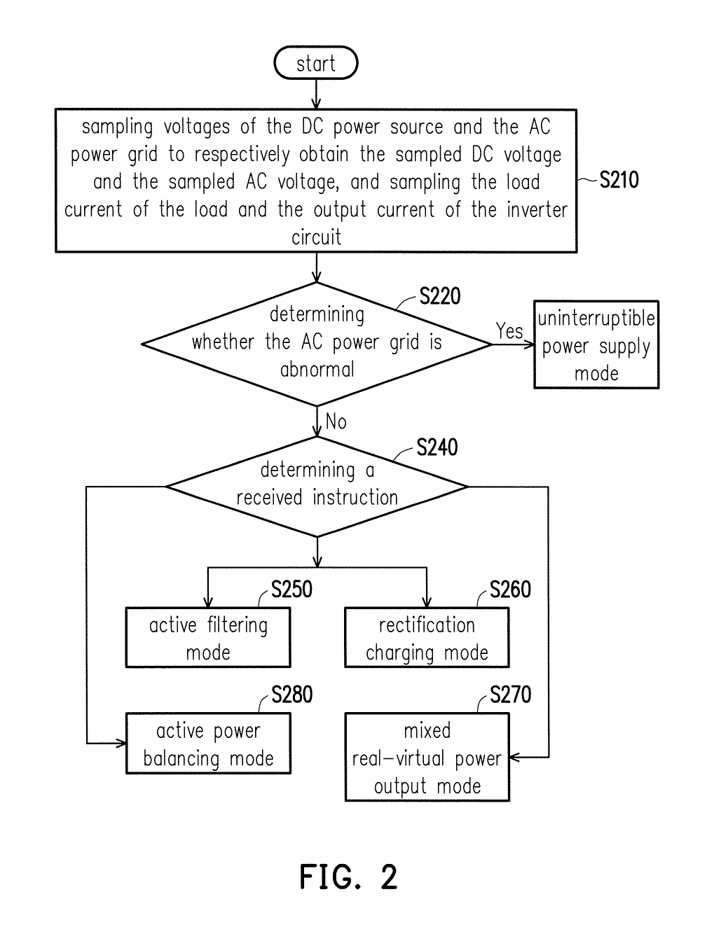

Regarding the operation procedure of the multi-function power converting apparatus of the present embodiment of the invention, please refer to FIG. 2. Specifically, in step S210, an operation of sampling voltages of the DC power source and the AC power grid to respectively obtain the sampled DC voltage and the sampled AC voltage, and sampling the load current of the load and the output current of the inverter circuit is executed. In step S220, it is determined whether functioning of the AC power grid is normal or not. If it is determined in step S220 that functioning of the AC power grid is abnormal, proceeding to step S230 to execute the uninterruptible power supply mode. Conversely, if it is determined in step S220 that functioning of the AC power grid is normal, the multi-function power converting apparatus is made to operate in one of the active filtering mode (step S250), the rectification charging mode (step S260), the mixed real-virtual power output mode (step S270), and the active power balancing mode (step S280) according to an instruction received in step S240.

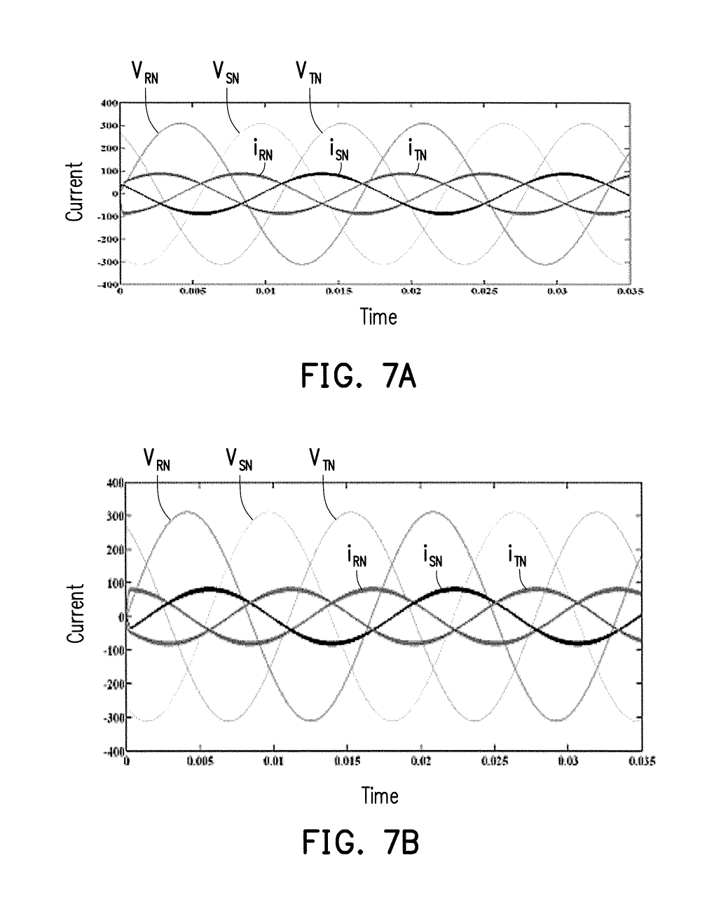

Referring to FIG. 8, FIG. 8 is a schematic diagram illustrating a multi-function power converting apparatus of another embodiment of the invention. A multi-function power converting apparatus 800 includes an inverter circuit 810, a controller 820, and a relay set 830. In the present embodiment, the inverter circuit 810 is a split-capacitor inverter circuit. Of course, the inverter circuit 810 illustrated in FIG. 8 is only an embodiment of the split-capacitor inverter circuit. Any split-capacitor inverter circuits that are familiar to people of ordinary skill in the art may all be applied to the invention.

The inverter circuit 810 is coupled to a load LD and a DC power source DCP, and is coupled to an AC power grid AGD via the relay set 830. The relay set 830 includes a plurality of switches constituted by relays and is configured to conduct/break a conducting path between the inverter circuit 810 and the AC power grid AGD. The controller 820 is coupled to the inverter circuit 810 and the relay set 830. The controller 820 samples voltages of the DC power source DCP and the AC power grid AGD to respectively obtain a sampled DC voltage and a sampled AC voltage, samples a load current of the load LD and an output current of the inverter circuit 810, and generates a control signal CTR according to the sampled DC voltage, the sampled AC voltage, the load current, and the output current.

The controller 820 causes the multi-function power converting apparatus 800 to operate in the uninterruptible power supply mode or the grid-connected power supply mode through the control signal CTR. When the multi-function power converting apparatus 800 operates in the grid-connected power supply mode, the controller 820 further generates the control signal CTR according to an instruction INST, and causes the multi-function power converting apparatus 800 to operate in one of the mixed real-virtual power output mode, the rectification charging mode, the active filtering mode, and the active power balancing mode through the control signal CTR.

It shall be mentioned that the controller 820 of the invention simultaneously provides functions to cause the multi-function power converting apparatus 800 to operate in the uninterruptible power supply mode, the mixed real-virtual power output mode, the rectification charging mode, the active filtering mode, and the active power balancing mode. Moreover, according to a functioning state of the power system, the multi-function power converting apparatus 800 is made to operate in one of the foregoing operation modes to enhance functioning efficiency of the power system.

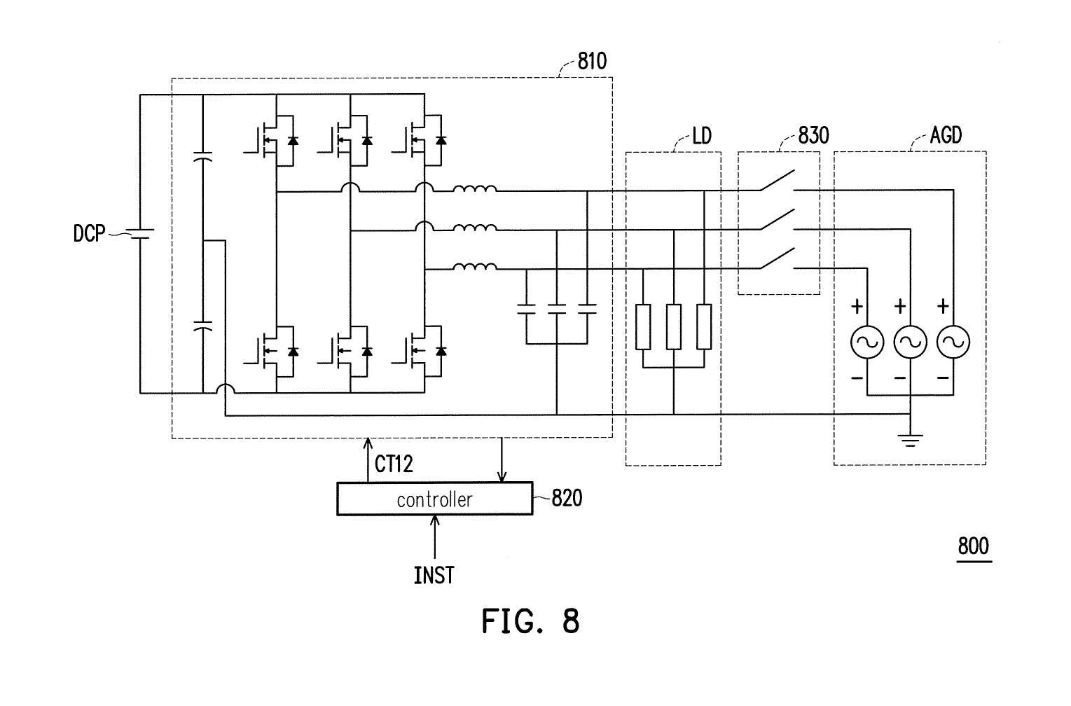

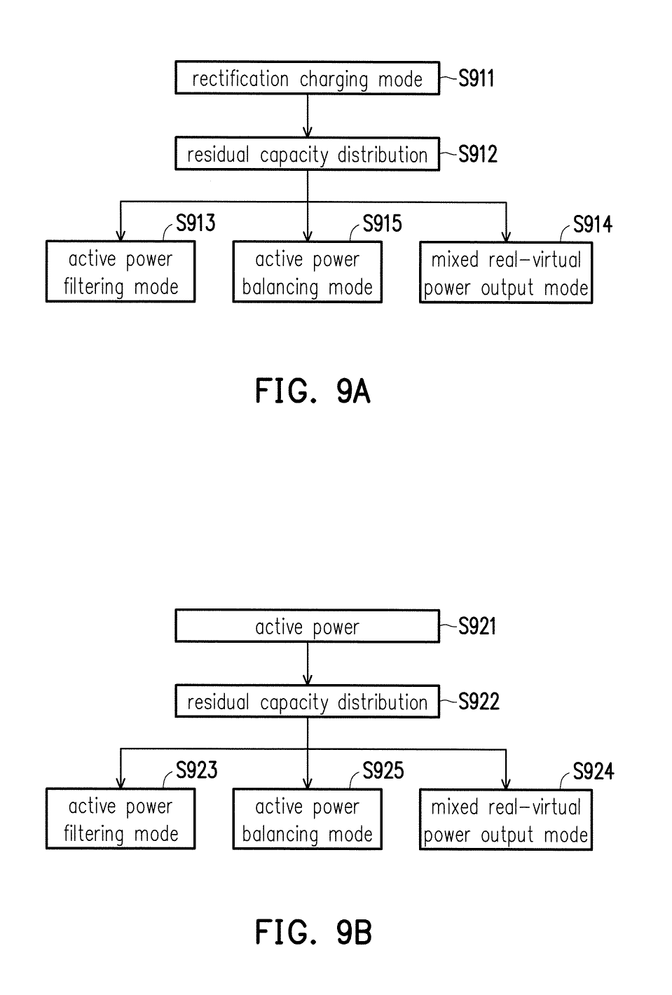

Taking an automated solar power generation system as an example, two scenarios usually apply to the automated solar power generation system. The first scenario is supplying power by an energy storage device (i.e., the DC power source) at night. The second scenario is generating power by a solar power panel during daytime. Referring to FIG. 9A illustrating a flowchart of a working procedure of a multi-function power converting apparatus of an embodiment of the invention. In the first scenario, when the energy storage device needs to be charged, in the present embodiment of the invention, the rectification charging mode is executed in step S911 to charge the energy storage device. However, the charging capacity is not necessarily the total capacity of the equipment. Therefore, residual power averaging is executed for the remaining capacity according to step S912, and the remaining capacity is applied to the active power filtering mode (step S913), the active power balancing mode (step S915), and the mixed real-virtual power output mode (step S914) to supply a virtual power. Of course, relative capacities of each of the modes may be detected and re-distributed here by means of software, for example.

As for the second scenario, referring to FIG. 9B illustrating a flowchart of another working procedure of a multi-function power converting apparatus of an embodiment of the invention. In conditions of different irradiation angles of the sun each day, different powers are output to the AC power grid. In other words, the remaining capacity at each time point of a day is not completely identical, and there is similarly the issue of the total capacity of the equipment not being effectively used. An improvement method thereof is as shown in FIG. 9B. Specifically, in step S922, an active power generated in step S921 timely distributes the residual capacity to the active power filtering mode (step S923), the active power balancing mode (step S925), and the mixed real-virtual power output mode (step S924) to supply a virtual power.

Similar to the example of solar power generation, the same method also applies to an example of wind power generation to enhance power supply efficiency. Therefore, for effective use of intermittent renewable energies and the total capacity of the equipment, it is indispensable to add a superimposed function that timely distributes the remaining capacity to other functions.

In summary of the above, the invention provides the multi-function power converting apparatus simultaneously having multi-phase functions that is adapted to execute different modes in response to different states that the power supply system undergoes. Accordingly, power supply efficiency of the power system is effectively enhanced.

Although the invention is disclosed in the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A multi-function power converting apparatus comprising:
an inverter circuit driving a load, the inverter circuit being coupled to a DC power source and an AC power grid and comprising a plurality of switches, wherein the switches perform switch operations according to a control signal to execute a power converting operation; and
a controller coupled to the inverter circuit, the DC power source, and the AC power grid, the controller sampling voltages of the DC power source and the AC power grid to respectively obtain a sampled DC voltage and a sampled AC voltage, sampling a load current of the load and an output current of the inverter circuit, and generating the control signal according to the sampled DC voltage, the sampled AC voltage, the load current, and the output current, wherein the controller causes the inverter circuit to enter an uninterruptible power supply mode or a grid-connected power supply mode through the control signal,
wherein the multi-function power converting apparatus operates in one of a mixed real-virtual power output mode, a rectification charging mode, an active filtering mode, and an active power balancing mode, when the inverter circuit enters the grid-connected power supply mode.

2. The multi-function power converting apparatus according to claim 1, wherein the controller determines whether functioning of the AC power grid is normal according to the sampled AC voltage, and causes the inverter circuit to enter the uninterruptible power supply mode when the AC power grid does not function normally.

3. The multi-function power converting apparatus according to claim 2, further comprising:
a relay set coupled between the inverter circuit and the AC power grid, wherein the controller causes the relay set to break connection between the inverter circuit and the AC power grid when the inverter circuit enters the uninterruptible power supply mode.

4. The multi-function power converting apparatus according to claim 2, wherein in the uninterruptible power supply mode, the controller generates the control signal to cause the inverter circuit to convert the voltage of the DC power source to generate an output voltage and drive the load through the output voltage.

5. The multi-function power converting apparatus according to claim 1, wherein in the grid-connected power supply mode, the controller further receives an instruction and causes the multi-function power converting apparatus to operate in one of the mixed real-virtual power output mode, the rectification charging mode, the active filtering mode, and the active power balancing mode according to the instruction.

6. The multi-function power converting apparatus according to claim 5, wherein in the mixed real-virtual power output mode, the controller further generates the control signal according to a power factor of the sampled AC voltage, and causes the inverter circuit to supply at least one of a real power and a virtual power of a positive value to the AC power grid.

7. The multi-function power converting apparatus according to claim 6, wherein the inverter circuit supplies the real power of the positive value to the AC power grid when the power factor is equal to 1.

8. The multi-function power converting apparatus according to claim 6, wherein the inverter circuit supplies the real power of the positive value to the AC power grid and the AC power grid absorbs the virtual power of the positive value when a phase of the power factor is leading.

9. The multi-function power converting apparatus according to claim 6, wherein the inverter circuit supplies the real power of the positive value and the virtual power of the positive value to the AC power grid when a phase of the power factor is lagging.

10. The multi-function power converting apparatus according to claim 5, wherein in the rectification charging mode, the controller generates the control signal to cause the inverter circuit to feed in a real power supplied by the AC power grid and generate a charging voltage, and causes the charging voltage to charge the DC power source.

11. The multi-function power converting apparatus according to claim 5, wherein the inverter circuit enters the active power filtering mode when a power demand of a pulse-type current surge arises in the load.

12. The multi-function power converting apparatus according to claim 5, wherein the inverter circuit supplies a plurality of output power sources of different phases, and the inverter circuit enters the active power balancing mode when a load demand of the output power sources is unbalanced.

13. The multi-function power converting apparatus according to claim 1, wherein the controller generates the control signal according to a D-sigma digital control algorithm.

14. The multi-function power converting apparatus according to claim 1, wherein the inverter circuit is a split-capacitor inverter circuit.
